(19) United States
(12) Patent Application Publication
(10) Pub. No.: US 2012/0032927 A1
(43) Pub. Date: Feb. 9, 2012

(54) TOUCH PANEL

(75) Inventors: Jae Il Kim, Gyunggi-do (KR); Yong Soo Oh, Gyunggi-do (KR); Jong Young Lee, Gyunggi-do (KR); Woon Chun Kim, Gyunggi-do (KR)

(73) Assignee: SAMSUNG ELECTRO-MECHANICS CO., LTD., Gyunggi-do (KR)

(21) Appl. No.: 12/960,111

(22) Filed: Dec. 3, 2010

(30) Foreign Application Priority Data
Aug. 3, 2010 (KR) 1020100075006

(51) Int. Cl. G06F 3/042

(52) U.S. Cl. 345/176

(57) ABSTRACT

Disclosed herein is a touch panel. The touch panel 100 includes a transparent substrate 110 partitioned into an active region 113 and a bezel region 115 provided at the edges of the active region 113, a transparent electrode 120 formed in the active region 113, and a wiring electrode 130 printed at the edges of the transparent electrode 120 to form a contact surface 140 with the transparent electrode 120, wherein the contact surface 140 is vertical to the transparent substrate 110 and extended to the bezel region 115, wherein the contact surface 140 is configured such that a convex portion 143 protrudes to the bezel region 115 and a concave portion 145 indented into the active region 113 are continued.

### CROSS REFERENCE TO RELATED APPLICATION

This application claims the benefit of Korean Patent Application No. 10-2010-0075006, filed on Aug. 3, 2010, entitled “Touch Panel”, which is hereby incorporated by reference in its entirety into this application.

### BACKGROUND OF THE INVENTION

1. Technical Field

The present invention relates to a touch panel.

2. Description of the Related Art

Alongside the growth of computers using digital technology, devices assisting computers have also been developed, and personal computers, portable transmitters and other personal information processors execute processing of text and graphics using a variety of input devices such as a keyboard and a mouse.

While the rapid advancement of the information-based society has been widening the use of computers more and more, there have been occurring the problems of it being difficult to efficiently operate products using only the keyboard and mouse as being currently responsible for the input device function. Thus, the demand for a device that is simple, does not malfunction, and has the capability to easily input information is increasing.

Furthermore, current techniques for input devices exceed the level of fulfilling general functions and thus are progressing towards techniques related to high reliability, durability, innovation, designing and manufacturing. To this end, a touch panel has been developed as an input device capable of inputting information such as text and graphics.

The touch panel is mounted on the display surface of an image display device such as an electronic organizer, a flat panel display including a liquid crystal display (LCD) device, a plasma display panel (PDP), an electroluminescence (El) element or the like, or a cathode ray tube (CRT), so that a user selects the information desired while viewing the image display device.

The touch panel is classifiable as a resistive type, a capacitive type, an electromagnetic type, a surface acoustic wave (SAW) type, and an infrared type. The type of touch panel selected is one that is adapted for an electronic product in consideration of not only signal amplification problems, resolution differences and the degree of difficulty of designing and manufacturing technology but also in light of optical properties, electrical properties, mechanical properties, resistance to the environment, input properties, durability and economic benefits of the touch panel. In particular, resistive and capacitive types are prevalently used in a broad range of fields currently.

However, the resistive touch panel and the capacitive touch panel according to the prior art has very high electrical resistance between a transparent electrode sensing a touch of an input unit and a wiring electrode receiving electrical signals from the transparent electrode. When the electrical resistance between the transparent electrode and the wiring electrode is high, there is a problem in that a touched sense is lowered no matter how the electrical conductivity of the transparent electrode itself is improved.

In addition, since adhesion between the transparent electrode and the wiring electrode is weak, the transparent electrode is separated from the wiring electrode when the touch panel is used for a long period of time, causing a problem in that durability of the touch panel is degraded.

### SUMMARY OF THE INVENTION

The present invention has been made in an effort to provide a touch panel capable of lowering electrical resistance between a transparent electrode and a wiring electrode and improving adhesion therebetween by configuring a contact surface of the transparent electrode and the wiring electrode to have a tooth shape or a concave and convex ( [symbol] ) shape.

A touch panel according to a preferred embodiment of the present invention includes: a transparent substrate partitioned into an active region and a bezel region provided at the edges of the active region; a transparent electrode formed in the active region; and a wiring electrode printed at the edges of the transparent electrode to form a contact surface with the transparent electrode, wherein the contact surface is vertical to the transparent substrate, and extended to the bezel region, wherein the contact surface is configured such that a convex portion protrudes to the bezel region and a concave region indented into the active region are continued.

Herein, an area of the convex portion and an area of the concave portion are the same.

Further, the convex portion and the concave portion have a tooth shape or a concave and convex ( [symbol] ) shape.

Further, the transparent electrode is formed over the active region.

Further, the transparent electrode is formed in a bar pattern or in a diamond pattern.

Further, the transparent electrode is made of a conductive polymer.

Further, the conductive polymer includes poly-3,4-ethylenedioxythiophene/polystyrenesulfonate (PEDOT/PSS), polyaniline, polyacetylene, or polyphenylenevinylene.

Further, the wiring electrode is formed by a screen printing method, a gravure printing method, or an inkjet printing method.

### BRIEF DESCRIPTION OF THE DRAWINGS

FIGS. 1 to 6 are plan views of a touch panel according to a preferred embodiment of the present invention;

FIG. 7 is a cross-sectional view taken along line A-A′ of the touch panel of FIG. 3; and

FIGS. 8 to 10 are cross-sectional views of a touch panel manufactured using a preferred embodiment of the present invention.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, in describing the present invention, a detailed description of related known functions or configurations will be omitted so as not to obscure the gist of the present invention.

Hereinafter, preferred embodiments of the present invention will be described in detail with reference to the accompanying drawings.

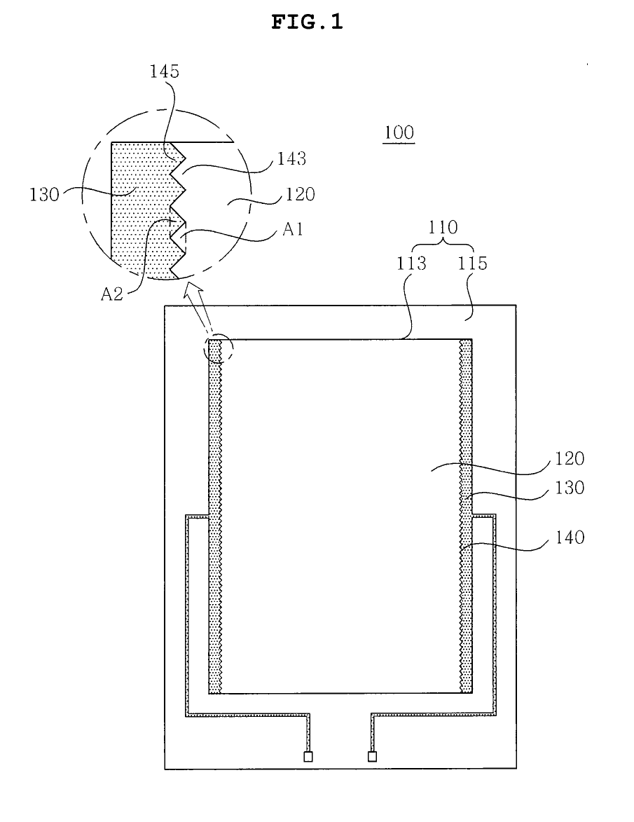

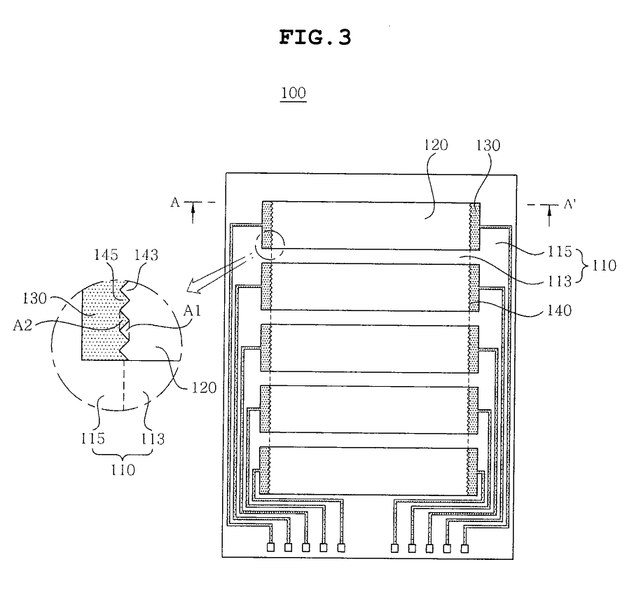

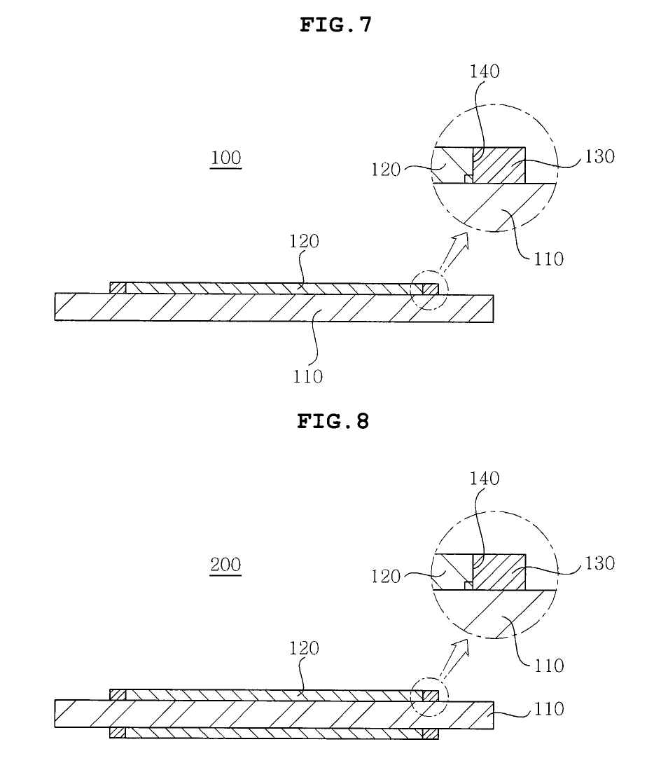

FIGS. 1 to 6 are plan views of a touch panel according to a preferred embodiment of the present invention, and FIG. 7 is a cross-sectional view taken along line A-A′ of the touch panel of FIG. 3.

Referring to FIGS. 1 to 7, a touch panel 100 according to an embodiment of the present invention includes a transparent substrate 110 partitioned into an active region 113 and a bezel region 115 provided at the edges of the active region 113, a transparent electrode 120 formed in the active region 113, and a wiring electrode 130 printed at the edges of the transparent electrode 120 to form a contact surface 140 with the transparent electrode 120, wherein the contact surface 140 is vertical to the transparent substrate 110 (see FIG. 7) and extended to the bezel region 115. Herein, the contact surface 140 is configured such that a convex portion 143 protrudes to the bezel region 115 and a concave portion 145 indented to the active region 113 are continued.

The transparent substrate 110 serves to provide a region in which the transparent electrode 120 and the wiring electrode 130 are to be formed. Herein, the transparent substrate 110 is partitioned into the active region 113 and the bezel region 115, wherein the active region 113, a portion in which the transparent electrode 120 is formed in order to recognize a user's touch, is provided in the center of the transparent substrate 110, and the bezel region 115, a portion in which the wiring electrode 130 conducted with the transparent electrode 120, is provided at the edges of the active region 113. At this time, the transparent substrate 110 should be provided with durability capable of supporting the transparent electrode 120 and the wiring electrode 130 and transparency through which a user can recognize an image provided from an image display apparatus. In consideration of the durability and transparency, the material of the transparent substrate 110 may include polyethyleneterephthalate (PET), polycarbonate (PC), polymethylmethacrylate (PMMA), polyethylenenaphthalate (PEN), polyethersulfone (PES), cyclic olefin copolymer (COC), triacetylcellulose (TAC) film, polyvinyl alcohol (PVA) film, polyimide (PI) film, polystyrene (PS), biaxially oriented polystyrene (BOPS; containing K resin), glass or reinforced glass and so on, but is not particularly limited thereto. Meanwhile, it is preferable that a high frequency treatment or a primer treatment is performed on the surface of the transparent substrate 110 in order to improve adhesion between the transparent substrate 110 and the transparent electrode 120.

The transparent electrode 120 serves to generate signals when the touch panel is touched by a user and allow a controller to recognize touched coordinates. The transparent electrode 120 is formed in the active region 113 of the transparent substrate 110. Herein, the transparent electrode 120 may include a conductive polymer having excellent flexibility and a simple coating process as well as indium tin oxide (ITO) that is commonly used. At this time, the conductive polymer includes poly-3,4-ethylenedioxythiophene/polystyrenesulfonate (PEDOT/PSS), polyaniline, polyacetylene, polyphenylenevinylene, or the like. In addition, the transparent electrode 120 may be formed by a dry etching process such as sputtering, evaporation or the like, a wet etching process such as dip coating, spin coating, roll coating, spray coating or the like, or a direct patterning process such as screen printing, gravure printing, inkjet printing or the like. In addition, the transparent electrode 120 may be formed in a film shape to be bonded to the transparent substrate 110 using optical clear adhesive (OCA).

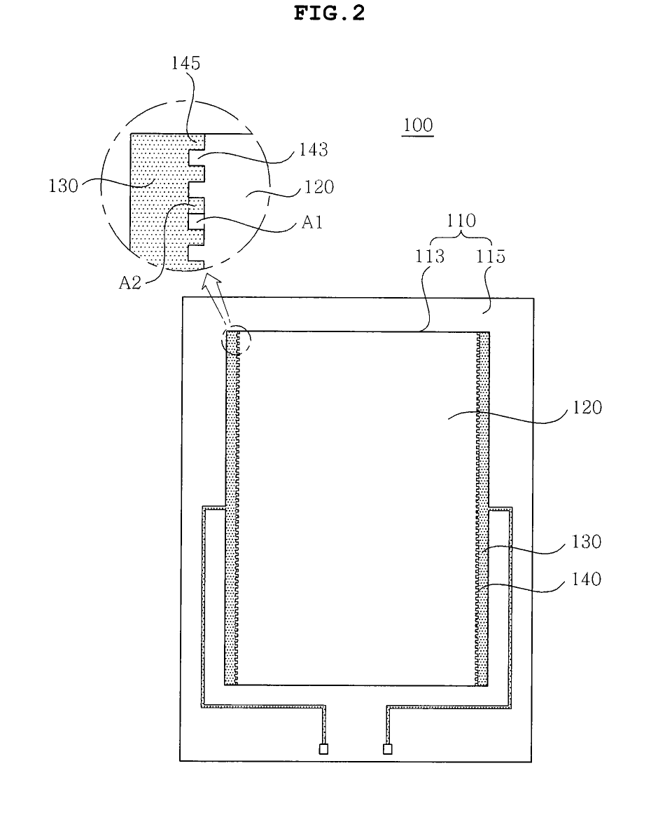

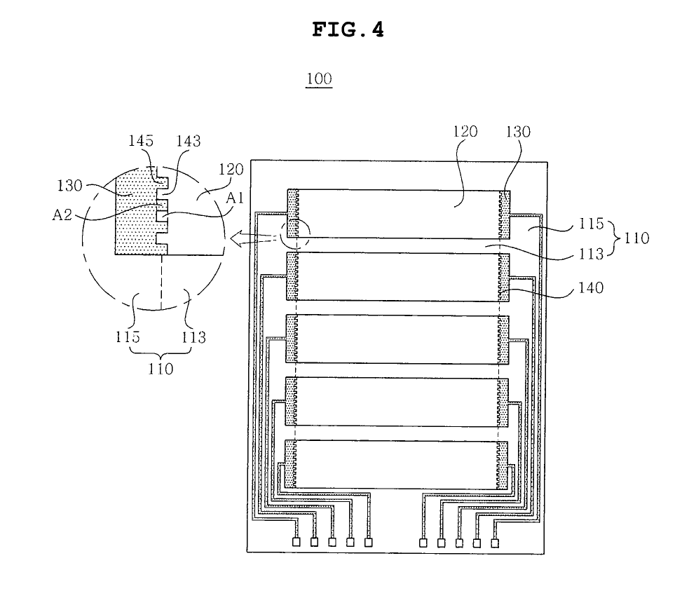

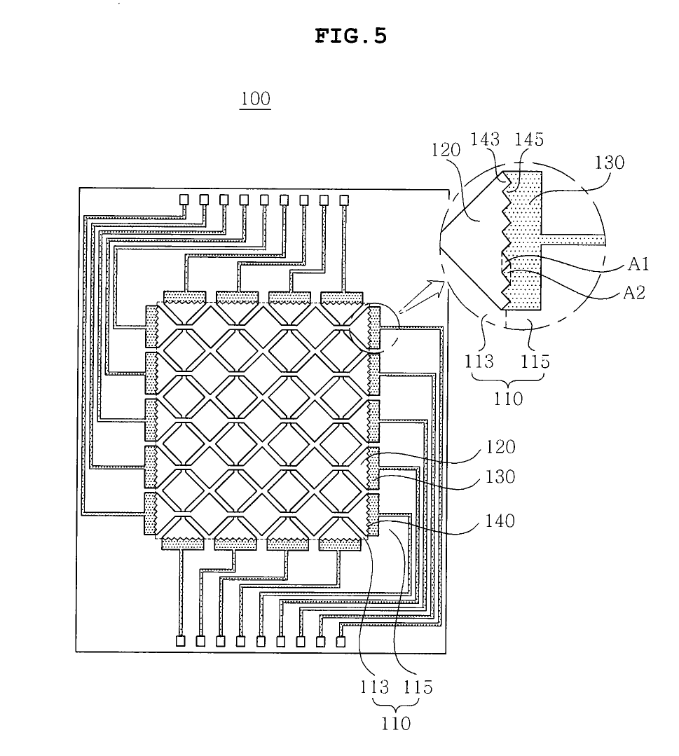

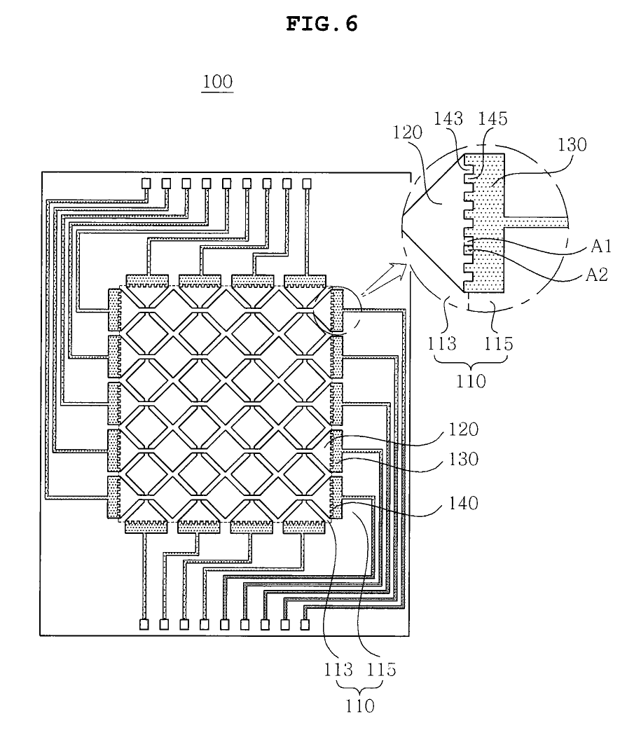

Meanwhile, the transparent electrode 120 may be formed in various patterns according to driving methods. For example, the transparent electrode 120 may be formed over the active region 113 (see FIGS. 1 and 2). Alternatively, the transparent electrode 120 may also be formed in a bar pattern (see FIGS. 3 and 4) or in a diamond pattern (see FIGS. 5 and 6).

The wiring electrode 130 is printed at the edges of the transparent electrode 120 so as to receive electrical signals from the transparent electrode 120. In this case, the wiring electrode 130 forms a contact surface 140 with the transparent electrode 120, wherein the contact surface 140 is vertical to the transparent substrate 110 (see FIG. 7). Herein, the contact surface 140 of the wiring electrode 130 and the transparent electrode 120 is configured such that the convex portion 143 protrudes to the bezel region 115 of the transparent substrate 110 and the concave portion 145 indented to the active region 113 of the transparent substrate 110 are continued, as shown in FIGS. 1 to 6. The contact surface 140 of the wiring electrode 130 and the transparent electrode 120 is configured of the continuous convex portion 143 and concave portion 145, such that the contact surface between the wiring electrode 130 and the transparent electrode 120 is increased. Therefore, the electrical resistance between the transparent electrode 120 and the wiring electrode 130 is lowered, thereby making it possible to improve sensitivity of the touch panel 100. Furthermore, the adhesion between the transparent electrode 120 and the wiring electrode 130 is increased, thereby making it possible to improve durability of the touch panel. In addition, it is preferable that an area A1 of the convex portion 143 and an area A2 of the concave portion 145 are constituted to be the same so that the electrical resistance between the transparent electrode 120 and the wiring electrode 130 is constant throughout the contact surface 140. In this case, the meanings of “the same” do not imply that the area A1 of the convex portion 143 and the area A2 of the concave portion 145 are mathematically completely the same but include that minute changes in areas due to processing errors, or the like generated during a manufacturing process of a touch panel. Meanwhile, a shape of the contact surface 140 is not particularly limited so far as the convex portion 143 and the concave portion 145 are continued. However, it is preferable that the contact surface 140 has a tooth shape in a triangle-wave form (see FIGS. 1, 3, and 5) or a concave and convex ( [symbol] ) shape in a square-wave form (see FIGS. 2, 4, and 6).

Alternatively, the wiring electrode 130 may be printed by using a screen printing method, a gravure printing method, an inkjet printing method, or the like. At this time, the wiring electrode 130 may be made of silver (Ag) paste or organic Ag having superior electrical conductivity, but the present invention is not limited thereto. In addition, a conductive polymer material, carbon black (including carbon nanotubes), or a low resistive metal including metal or a metal oxide such as ITO may be used. Meanwhile, the wiring electrodes 130 are extended to the bezel region 115 from the edges of the transparent electrode 120 to be collected at one side or at both sides thereof, such that the collected wiring electrodes 130 are electrically connected to a controller through a flexible printed circuit (FPC). The wiring electrode 130 is connected to both ends of the transparent electrode 120 in the drawings, but this is merely exemplary case. The wiring electrodes 130 may also be connected to only one end of the transparent electrode 120 according to the type of touch panel 100.

As shown in FIG. 7, in the case of the touch panel 100 according to the present embodiment, a self capacitive touch panel or a mutual capacitive touch panel may be manufactured by using the transparent electrode 120 having a single layer structure and various shapes of touch panels including the constitutions as described above may also be manufactured as follows.

FIGS. 8 to 10 are cross-sectional views of a touch panel manufactured using a preferred embodiment of the present invention.

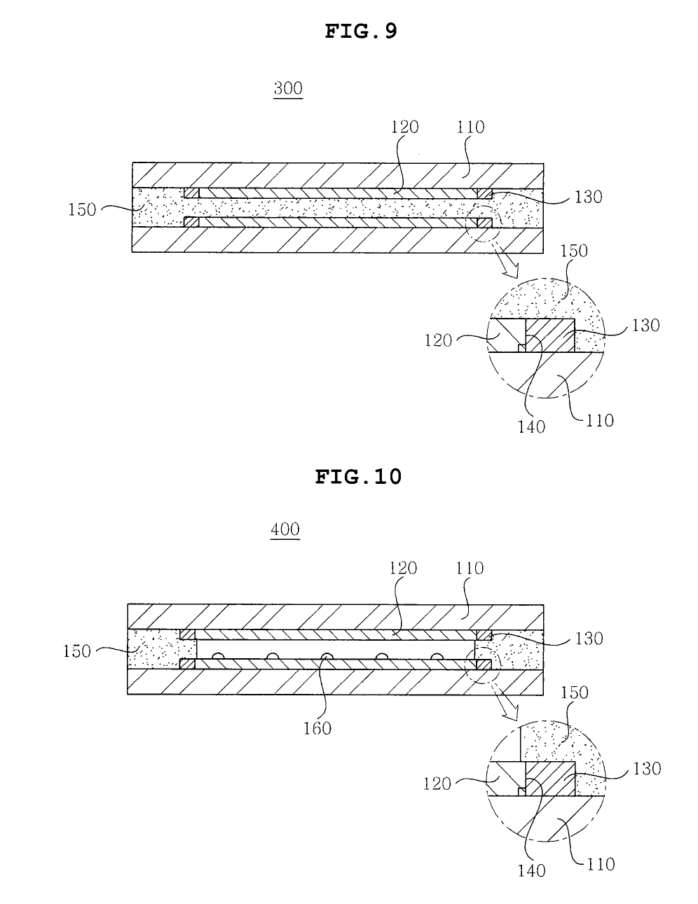

As shown in FIG. 8, a mutual capacitive touch panel 200 (see FIG. 8) may be manufactured by forming the transparent electrodes 120 on both surfaces of the transparent substrate 110, respectively. As shown in FIGS. 9 and 10, a mutual capacitive touch panel 300 (see FIG. 9) or a resistive touch panel 400 (see FIG. 10) may be manufactured by including two transparent substrates 110 having the transparent electrode 120 formed on one surface thereof and bonding the two transparent substrates 110 using an adhesive layer 150 so that the transparent electrodes 120 face each other. Herein, in the case of the mutual capacitive touch panel 300 (see FIG. 9), the adhesive layer 150 is bonded over the transparent electrode 120 so that the two transparent electrodes 120 facing each other are insulated from each other. In addition, in the case of the resistive touch panel 400 (see FIG. 10), the adhesive layer 150 is bonded to only the edges of the transparent electrode 120 so that the two transparent electrodes 120 facing each other are contacted when a user's pressure is applied and a dot spacer 160 that provides repulsive force is provided on an exposed surface of the transparent electrode 120 so that the transparent electrode 120 is returned to its original position when the user's pressure is removed.

The touch panels 200, 300, and 400 manufactured using the preferred embodiments of the present invention also configure the contact surface 140 of the transparent electrode 120 and the wiring electrode 130 to have a tooth shape or a concave and convex ( [symbol] ) shape to lower the electrical resistance between the transparent electrode 120 and the wiring electrode 130, thereby making it possible to improve sensitivity of the touch panels 200, 300, and 400. In addition, the adhesion between the transparent electrode 120 and the wiring electrode 130 is increased, thereby making it possible to improve durability of the touch panels 200, 300, and 400.

According to the present invention, the contact surface of the transparent electrode and the wiring electrode is configured to have a tooth shape or a concave and convex ( [symbol] ) shape to lower the electrical resistance between the transparent electrode and the wiring electrode, thereby making it possible to improve sensitivity of the touch panel. In addition, the adhesion between the transparent electrode and the wiring electrode is increased, thereby making it possible to improve durability of the touch panel.

Although the preferred embodiments of the present invention have been disclosed for illustrative purposes, they are for specifically explaining the present invention and thus a touch panel according to the present invention is not limited thereto, but those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. A touch panel, comprising:
a transparent substrate partitioned into an active region and a bezel region provided at the edges of the active region;
a transparent electrode formed in the active region; and
a wiring electrode printed at the edges of the transparent electrode to form a contact surface with the transparent electrode, wherein the contact surface is vertical to the transparent substrate, and extended to the bezel region,
wherein the contact surface is configured such that a convex portion protrudes to the bezel region and a concave region indented into the active region are continued.

2. The touch panel as set forth in claim 1, wherein an area of the convex portion and an area of the concave portion are the same.

3. The touch panel as set forth in claim 1, wherein the convex portion and the concave portion have a tooth shape or a concave and convex ( [symbol] ) shape.

4. The touch panel as set forth in claim 1, wherein the transparent electrode is formed over the active region.

5. The touch panel as set forth in claim 1, wherein the transparent electrode is formed in a bar pattern or in a diamond pattern.

6. The touch panel as set forth in claim 1, wherein the transparent electrode is made of a conductive polymer.

7. The touch panel as set forth in claim 6, wherein the conductive polymer includes poly-3,4-ethylenedioxythiophene/polystyrenesulfonate (PEDOT/PSS), polyaniline, polyacetylene, or polyphenylenevinylene.

8. The touch panel as set forth in claim 1, wherein the wiring electrode is formed by a screen printing method, a gravure printing method, or an inkjet printing method.
